(19) United States
(12) Patent Application Publication
(10) Pub. No.: US 2019/0269062 A1
(43) Pub. Date: Sep. 5, 2019

(54) REPLACEMENT EDGER BLADE

(71) Applicant: Darren Rhoades, Idaho Falls, ID (US)

(72) Inventor: Darren Rhoades, Idaho Falls, ID (US)

(21) Appl. No.: 16/290,023

(22) Filed: Mar. 1, 2019

Related U.S. Application Data
(60) Provisional application No. 62/637,170, filed on Mar. 1, 2018.

(51) Int. Cl. A01B 35/28

(52) U.S. Cl. CPC A01B 35/28

(57) ABSTRACT

An edger blade is provided. The edger blade may include a body member having a hub with a mounting aperture extending through the hub. The edger blade has two hammer portions coupled to and extending in opposite directions from the hub. Each hammer portion includes an arm and a hammer head. The arm is coupled between the hub and the hammer head. In embodiments, the body member may be a unitary body formed of AR 400 steel alloy and the arm may include an aperture extending therethrough. Further, in embodiments, the aperture through the arm may have a softer material coupled within the aperture.

### CROSS REFERENCE TO RELATED APPLICATION[S]

This application claims priority to U.S. Provisional Patent Application entitled “REPLACEMENT EDGER BLADE,” Ser. No. 62/637,170, filed Mar. 1, 2018, the disclosure of which is hereby incorporated entirely herein by reference.

### BACKGROUND OF THE INVENTION

### Technical Field

This invention relates generally to blades for an edger, and more particularly to a hammer shaped edger blade with better wear resistance.

### State of the Art

The use of an edger is common in landscaping. An edger operates to point the blade between the edge of curbing, sidewalk, driveway, a garden bed or the like and a grass lawn. The edger blade digs a slight trench during operation to give the lawn a nice sharp edge. Obstacles, such as, rocks, tree roots, cement or other obstacles provide significant wear to the blades. Further, hardened ground also operates to wear the blades. The manufacture and dimensions of the blades also contribute to early wear of conventional blades. Conventional blades of an edger typically last approximately 2 days during commercial landscaping use. The speed of the wear of the blades of the edger requires frequent changes of the blades and increases the cost of performing landscaping operations.

Accordingly, there is a need for an improved blade for use with an edger.

### SUMMARY OF THE INVENTION

The present invention relates to a replacement edger blade for use with a commercial edger.

An embodiment includes an edger blade comprising: a body member, wherein the body member further comprises: a hub with a mounting aperture extending through the hub; and two hammer portions coupled to and extending in opposite directions from the hub, each hammer portion having an arm and a hammer head, wherein the arm is coupled between the hub and the hammer head.

Another embodiment includes an edger blade comprising: a unitary body member, wherein the unitary body member further comprises a hub with a mounting aperture extending through the hub; and two hammer portions extending in opposite directions from the hub, each hammer portion having an arm and a hammer head, wherein the arm is formed between the hub and the hammer head; and an aperture extending through the arm of each hammer portion. In embodiments, the unitary body member may be formed of a steel alloy, such as, but not limited to AR 400. Further, a metal softer than AR 400 may be coupled within the aperture of the arm of each hammer portion.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a perspective view of an edger blade according to embodiments;

FIG. 2 is a front view of an edger blade according to embodiments;

FIG. 3 is a side view of an edger blade according to embodiments;

FIG. 4 is another perspective view of an edger blade according to embodiments; and

FIG. 5 is a front view of an edger blade with the hammer head worn according to embodiments.

### DETAILED DESCRIPTION OF EMBODIMENTS OF THE INVENTION

As discussed above, embodiments of the present invention relate to a replacement edger blade for use with a commercial edger.

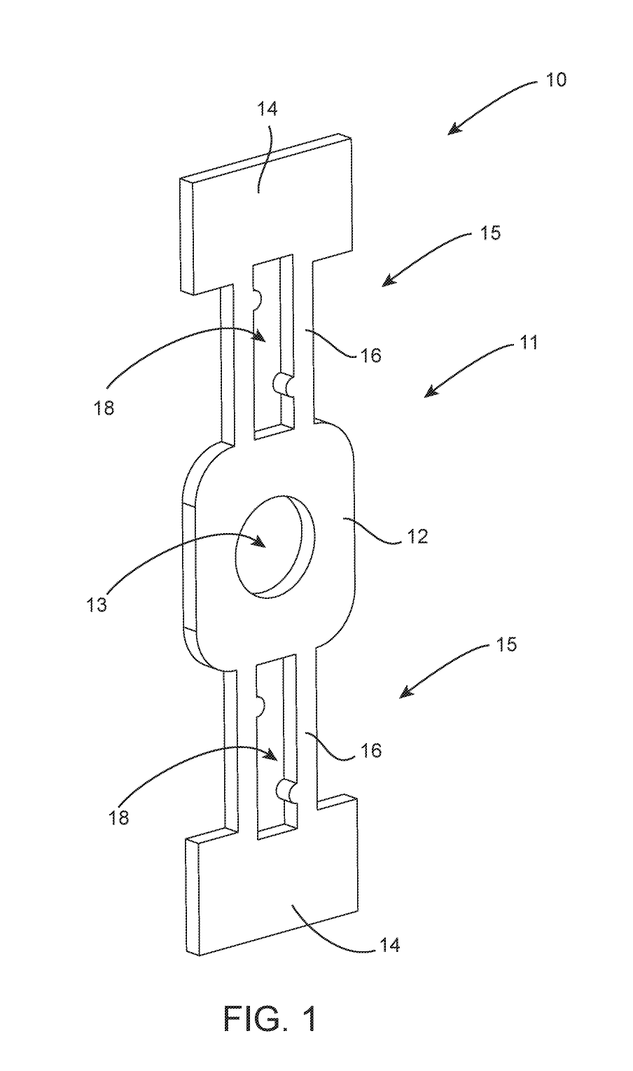

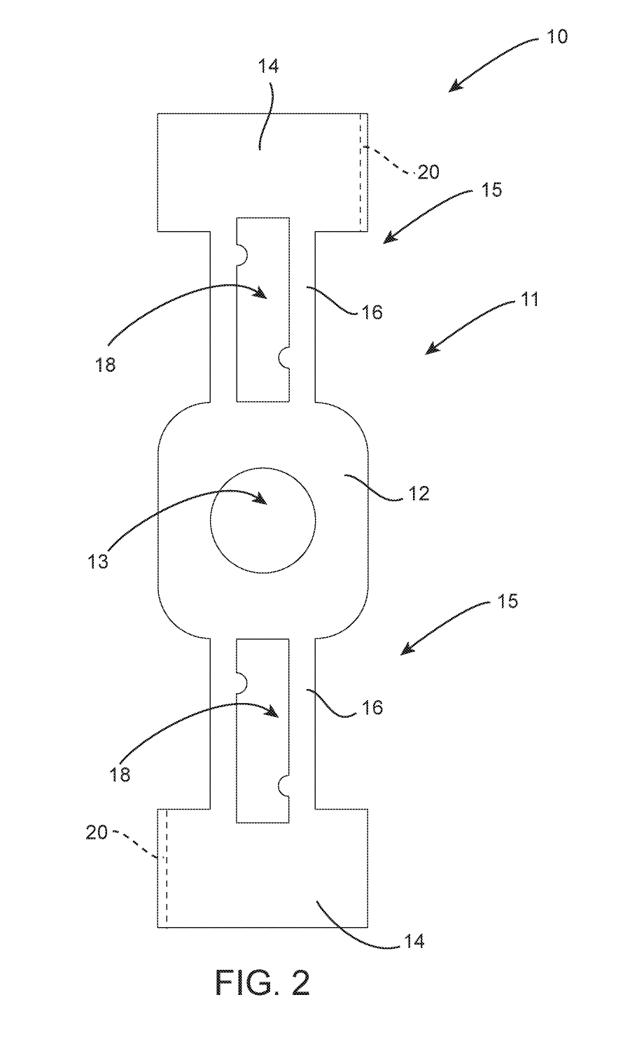

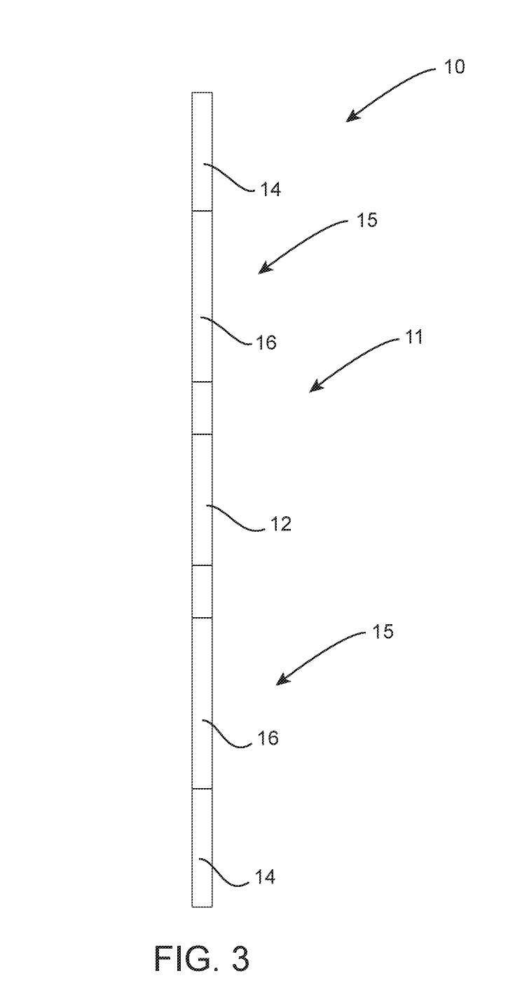

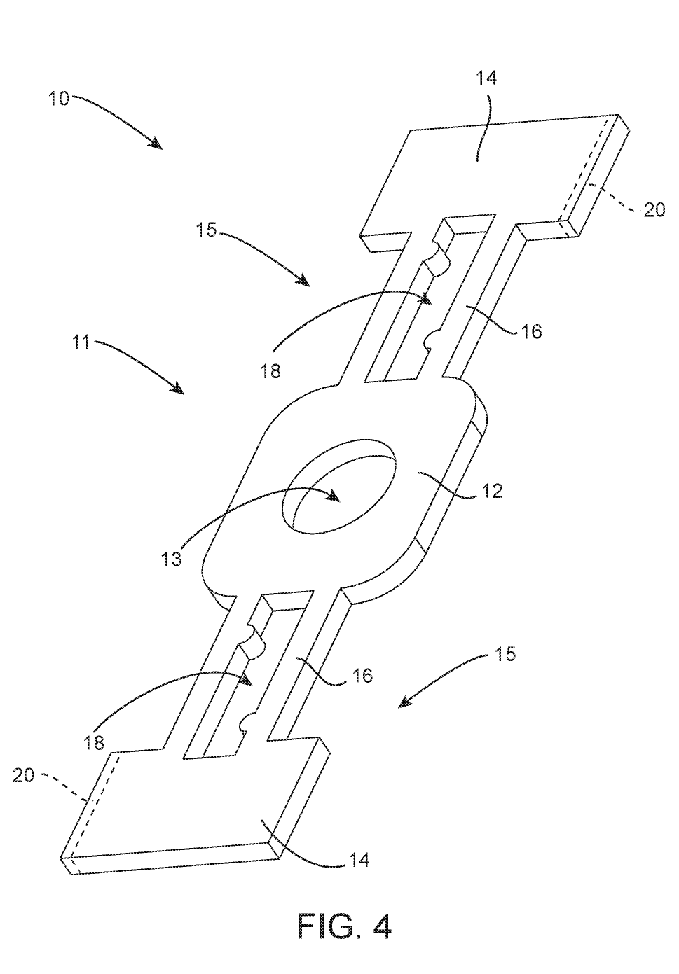

Referring to the drawings, FIGS. 1-4 illustrate an edger blade 10 according to an embodiment. The edger blade 10 includes a body member 11 having a hub 12, and hammer portions 15 extending in opposite directions from the hub 12. The hub 12 comprises a mounting aperture 13 extending through a center of the hub 12. The mounting aperture 13 provides a means to operatively couple the blade 10 to an edger (not shown). This allows the blade 10 to rotate and edge, or cut edges in, grass, and the like, along an edge of the lawn portion, such as by curbing, a sidewalk, a garden bed or the like.

Each hammer portion 13 includes a hammer head 14 and an arm 16. The arm 16 is coupled between the hub 12 and the hammer head 14. The arm has a width that is less than the width of the hammer head 14. The hammer portion 13 is a T-shaped member with an arm 16 forming a leg of the T and the hammer head 14 forming the cross member of the T. In embodiments, the arm 16 may comprise an aperture 18. The aperture 18 may serve to reduce weight of the blade 10.

In some embodiments, as shown in the drawing figures, the body member 11 may be a unitary body member 11 formed of a monolithic piece of material. In some embodiments, the material may be an abrasion-resistant tempered steel. For example, and without limitation, the material may be AR 400 steel alloy.

In some embodiments, the hammer head 14 may include a hard-facing portion 20. The hard-facing portion 20 may be formed on the leading edge of the hammer head 14. The hard-facing portion 20 is harder than the other materials of the body member 11 and lengthens the life of the hammer head 14 by further resisting wear during operation.

Additionally, in some embodiments, the aperture 18 may be filled with another material softer than the other materials of the body member 11. For example, the aperture may be filled with a metal softer than the AR 400 or other materials of the body member 11. In some embodiments, the softer material may have a thickness that is less than the thickness of other portions of arm 16. The softer material filling the aperture 18 serves to prevent the more brittle material of the body member 11 from flying away if there is a fracture in the edger blade 10. The softer material will not fracture as easily and will keep the fractured material from flying away and causing damage or injury.

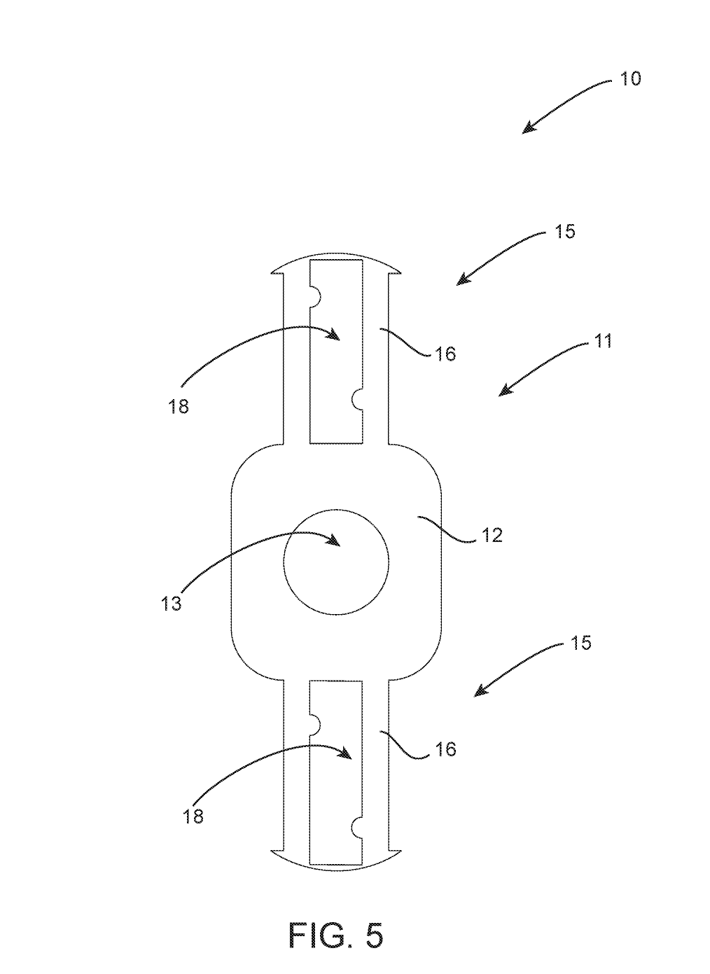

Referring to FIG. 5, during operation, the edger blade 10 begins to wear during cutting or edging. The hammer portion 15 serves to provide an indication of when to replace the blade 10. For example, and without limitation, a demarcation on the hammer portion 15 may mark the wear level to replace the blade. In other embodiments and as depicted in FIG. 5, the wearing of the entire hammer head indicates that the blade 10 needs to be replaced in the edger.

The edger blade 10 may have a thickness that is thicker than conventional blades. For example, in some embodiments, the thickness of the blade may be from 3/16 inch to 5/16 inch. The thicker edger blade 10 is more resistant to wear in comparison to conventional blades.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. An edger blade comprising:
a body member, the body member further comprising:
a hub with a mounting aperture extending through the hub; and
two hammer portions coupled to, and extending in opposite directions from, the hub, each hammer portion having an arm and a hammer head, wherein the arm is coupled between the hub and the hammer head.

2. The edger blade of claim 1, wherein the body member has a thickness within the range of 3/16 inch to 5/16 inch.

3. The edger blade of claim 1, wherein the body member is formed of a steel alloy.

4. The edger blade of claim 3, wherein the body member is formed of an AR 400 steel alloy.

5. The edger blade of claim 1, wherein the arm of each hammer portion further comprises an aperture therethrough.

6. The edger blade of claim 5, wherein the aperture through the arm is filled with a fill material that is lighter than the materials of the arm.

7. The edger blade of claim 6, wherein the fill material has a thickness that is less than the thickness of the arm.

8. The edger blade of claim 1, wherein the hammer head of each hammer portion further comprises a hard-facing portion formed on the leading edge thereof.

9. The edger blade of claim 8, wherein the hard-facing portion is harder than the other materials of the body member.

10. An edger blade comprising:
a unitary body member, the unitary body member further comprising:
a hub with a mounting aperture extending through the hub; and
two hammer portions extending in opposite directions from the hub, each hammer portion having an arm and a hammer head, wherein the arm is formed between the hub and the hammer head.

11. The edger blade of claim 10, wherein the body member has a thickness within the range of 3/16 inch to 5/16 inch.

12. The edger blade of claim 10, wherein the body member is formed of a steel alloy.

13. The edger blade of claim 11, wherein the body member is formed of an AR 400 steel alloy.

14. The edger blade of claim 10, wherein the arm of each hammer portion further comprises an aperture therethrough.

15. The edger blade of claim 14, wherein the aperture through the arm is filled with a fill material that is lighter than the materials of the arm.

16. The edger blade of claim 15, wherein the fill material has a thickness that is less than the thickness of the arm.

17. The edger blade of claim 10, wherein the hammer head of each hammer portion further comprises a hard-facing portion formed on the leading edge thereof.

18. The edger blade of claim 17, wherein the hard-facing portion is harder than the other materials of the body member.
